(19) United States
(12) Patent Application Publication
(10) Pub. No.: US 2025/0241310 A1
(43) Pub. Date: Jul. 31, 2025

(54) METHODS AND COMPOSITION FOR CONTROLLING PESTS

(71) Applicants: UPL CORPORATION LIMITED, Port Louis (MU); UPL EUROPE LTD., Cheshire (GB); Mitsui Chemicals Crop & Life Solutions, Inc., Tokyo (JP)

(72) Inventor: Gustavo Rodrigues Gonella LUIS, Tatui SP (BR)

(21) Appl. No.: 18/704,200

(22) PCT Filed: Oct. 27, 2022
(86) PCT No.: PCT/IB2022/060335

§ 371 Date: Apr. 24, 2024

(30) Foreign Application Priority Data
Oct. 28, 2021 (IN) 202111049368

(51) Int. Cl. A01G 13/10; A01N 43/40; A01N 43/56; A01N 47/34; A01P 7/04

(52) U.S. Cl. CPC A01N 43/40; A01N 43/56; A01N 47/34; A01P 7/04

(57) ABSTRACT

The present invention discloses a method for controlling corn pests. More particularly, the present invention relates to a method of controlling infestation of corn pests and a composition comprising pyridylidene class of insecticide for controlling the corn pests.

### FIELD OF INVENTION

The present invention relates to a method for controlling corn pests. More particularly, the present invention relates to a method of controlling infestation of corn pests and a composition comprising pyridylidene class of insecticide for controlling the corn pests.

### BACKGROUND OF INVENTION

Corn (Maize) is one of the main cereals produced in United States, China, India and Brazil. Maize productivity is highly affected by pests such as Spodoptera frugiperda ((Lepidoptera: Noctuidae)), Diabrotica speciosa (Coleoptera: Chrysomelidae) and Dalbulus maidis (Hemiptera: Cicadellidae). The Spodoptera frugiperda, Diabrotica virgifera and Dalbulus maidis are serious emerging pest of maize crops in USA and Brazil respectively. D. speciosa feeds on corn roots and compromises the capacity of plants to absorb water and nutrients, making it less productive and more susceptible to root diseases and tipping. On the other hand, Dalbulus maidis is considered one of the primary vector species of pathogens, besides causing direct damage by sap-sucking. The corn leafhopper is the cause of serious losses in corn yield for its capacity to transmit plant pathogens. They are also active phloem feeders, that insert stylets into the plant as they feed. Eventually, this leads to reduced yield and compromises the economic viability of farms.

The control of this pests is mainly based on the use of tolerant hybrids, selective insecticides application and seed treatment. However, constant changes of climatic conditions and pest species, behaviour as well as the occurrence of insecticide-resistant pest population have led to inconsistent results of this chemical control in cornfields. Yet, even with the existence of insecticidal molecules of good efficacy, the application technology is still a limiting factor, since the quality of the deposition directly influences the biological efficacy of these molecules.

There are methods known for controlling the corn root worms using biopesticides such as disclosed in US20220142175A1, U.S. Pat. No. 5,906,818A, WO1998050422A1. Nevertheless, development of new chemical classes of insecticides is of utmost importance to keep key invertebrate pests under economic damage thresholds and thus to guarantee sustainable yields of commodities in order to supply affordable food for a growing world population.

Flupyrimin [N-[(E)-1-(6-chloro-3-pyridinylmethyl)pyridin-2 (1H)-ylidene]-2,2,2-trifluoroacetamide], a nicotinic acetylcholine receptor (nAChR) competitive modulator, has unique biological properties, including outstanding potency to imidacloprid-resistant rice pests together with superior safety toward pollinators.

Plants are subject to injury by invertebrate pests at all stages of growth, beginning with seeds or other propagules such as bulbs, tubers, rhizomes, corms, roots and stem and leaf cuttings and ending with mature plants. There is a need for corrective treatments to keep them under economic damage thresholds. Further the purpose of coping with the global increase in population, efforts have been made to increase the yield of crops. However, since there is a significant decrease in the yield of crops caused by insect damage, there is a demand for a method for controlling crop damaging pests.

The present invention addresses this problem and other needs existing in the art. The present invention is thus directed to a method of controlling and/or preventing infestation by pests in agronomical crops, particularly corn crop.

### OBJECTS OF THE INVENTION

Thus, it is an object of the present invention to provide a solution for control of infestation by pests in corn.

It is another object of the present invention to deliver a complete pesticidal solution to control/prevent infestation by insects in corn, wherein the insect pests have become resistant to already used insecticides.

It is yet another object of the present invention to provide a method of controlling and/preventing infestation by pests in corn by applying an insecticide of high efficacy which when applied at lower doses liberates corn from damaging insect pests while ensuring eco-friendliness.

It is also an object of the present invention to increase the yield of corn by providing an effective insecticidal solution.

### SUMMARY OF INVENTION

In an aspect, the present invention provides a method of controlling the undesired pests, the method comprising applying an insecticidal composition of the present invention to the infested locus.

In an aspect of the present invention, there is provided a method controlling corn insect pests comprising applying to a plant, plant part or at a locus thereof an insecticide having a nicotinic acetylcholine receptor (nAChR) competitive modulatory activity. The said insecticide is a pyridylidene compound. Preferably, the said insecticide, a pyridylidene compound is flupyrimin.

In another aspect, there is provided a method of controlling corn insect pests that are resistant to conventional insecticides for example neonicotinides, comprising applying to plant or plant part or at a locus thereof, a pyridylidene class of insecticide having nicotinic acetylcholine receptor (nAChR) competitive modulatory activity, wherein the said insect pests are resistant to conventionally used insecticides.

In another aspect, the present invention provides a method for controlling insects in corn comprising contacting the plant, parts of it, its propagation material, seeds, roots, the pests, their food supply, habitat or breeding grounds with an agrochemical composition comprising flupyrimin or agriculturally acceptable salts or ester thereof.

In another aspect, the present invention provides a method of controlling and/or preventive infestation of pests and protecting the plant from corn rootworm, fall armyworm and corn leafhopper infestation comprising applying a composition comprising flupyrimin to a plant which includes any part of the plant and its roots or seeds or to its environment which includes the soil surrounding the plant.

In another aspect the present invention provides an insecticide composition for controlling and/or preventing plant infestation in corn, the composition comprising a nicotinic acetylcholine receptor (nAChR) competitive modulator optionally with agrochemically acceptable excipients, the nicotinic acetylcholine receptor (nAChR) competitive modulator is flupyrimin.

In yet another aspect, present invention provides the use of insecticide composition comprising flupyrimin f or agriculturally acceptable salts or ester thereof for controlling and/or preventing corn pests.

Yet another aspect of the present invention provides use of flupyrimin to control resistant and non-resistant corn pests and optionally flupyrimin is applied in combination with another insecticide.

In another aspect, the present invention provides a method of liberating the corn crop from resistant and non-resistant pests comprising applying flupyrimin to corn seed and/or corn plantation or any parts thereof.

In another aspect, the present invention relates to a method for increasing the crop yield by controlling the pests in corn crop with a composition comprising flupyrimin.

### DETAILED DESCRIPTION OF INVENTION

The following description is provided to assist in a comprehensive understanding of exemplary embodiments of the invention. It includes various specific details to assist in that understanding but these are to be regarded as merely exemplary.

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention are provided for illustration purpose only and not for limiting the scope of the invention.

It is to be understood that the singular forms “a,” “an,” and “the” include plural referents unless the context clearly dictates otherwise.

Features that are described and/or illustrated with respect to one embodiment may be used in the same way or in a similar way in one or more other embodiments and/or in combination with or instead of the features of the other embodiments. As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The term “locus” as used herein refers to a place to which a composition according to the invention is applied. It includes application to an individual plant, a group of plants such as a plant and/or its surrounding, and the region in which plants may be planted. The term “insects” includes all organisms in the class “Insecta”. Insecticidal term refers to the ability of a substance to increase mortality or inhibit, growth rate of insects. The term resistance may be partial or complete and it will be appreciated that all degrees of resistance are included in the meaning of this term, whether they be very low resistance, low resistance, high resistance, very high resistance or total resistance.

The term “contacting” used herein includes both direct contact (applying the compounds/compositions directly on the animal pest or plant, typically to the seeds, foliage, stem or roots of the plant) and indirect contact (applying the compounds/compositions to the locus of the animal pest or plant). To “control” or “controlling” insects means to inhibit, through a toxic effect, the ability of insect pests to survive, grow, feed, and/or reproduce, or to limit insect-related damage or loss in crop plants. To “control” insects may or may not mean killing the insects, although it preferably means reducing insect population by killing the insects.

As used herein, the term “propagule” means a seed or a regenerable plant part.

The term “regenerable plant part” means a part of a plant other than a seed from which a whole plant may be grown or regenerated when the plant part is placed in horticultural or agricultural growing media such as moistened soil, peat moss, sand, vermiculite, perlite, rock wool, fiberglass, coconut husk fiber, tree fern fiber and the like, or even a completely liquid medium such as water. Regenerable plant parts commonly include rhizomes, tubers, bulbs and corms of such geophytic plant species as potato, sweet potato, yam, onion, dahlia, tulip, narcissus, etc. Regenerable plant parts can also include other plant parts such as cut or separated stems and leaves from which some species of plants can be grown using horticultural or agricultural growing media. Regenerable plant parts include plant parts that are divided (e.g., cut) to preserve their ability to grow into a new plant. Therefore, regenerable plant parts include viable divisions of rhizomes, tubers, bulbs and corms which retain meristematic tissue, such as an eye.

As used herein the term “seed” includes both unsprouted seeds and sprouted seeds in which the testa (seed coat) still surrounds part of the emerging shoot and root.

The term ‘plants’ refers to all physical parts of a plant, including seeds, seedlings, saplings, roots, tubers, stems, stalks, foliage and fruits.

The term “crop” refers both to growing and harvested crops.

The term “agriculturally acceptable amount of active” refers to an amount of an active that kills or inhibits the pest on which control is desired, in an amount not significantly toxic to the plant being treated.

According to the present invention, “increased yield” of an agricultural plant means that the yield of a product of the respective plant is increased by a measurable amount over the yield of the same product of the plant produced under the same conditions, but without the application of the present invention. According to the present invention, it is preferred that the yield be increased by at least 0.5%, preferably at least by 2%, more preferably at least by 5%.

To “control” or “controlling” means to inhibit, and/or supress the ability of the insect to grow and/or proliferate, or to limit insect related damage or loss in crop plants or denotes control and prevention of the insects. Controlling effects include all deviation from natural development, for example: killing, retardation, decrease in insect population.

Thus, present invention is directed to a method for reducing damage by harmful pests in corn cultivation.

In an aspect the present invention provides a method of controlling and/preventing infestation of corn insects comprising contacting targeted pests with insecticidal composition comprising the compound of the present invention, an active pyridylidene class of compound particularly flupyrimin.

Another aspect of the present invention provides a method of controlling insects in corn plantation comprising applying flupyrimine or an agriculturally acceptable salt thereof on a plant or a part thereof or at the locus or on a plant propagation material.

In another aspect, the present invention provides the use of the compounds of the invention for controlling pests that are resistant to one or more other insecticides, preferably pyrethroids, neonicotinoids and organophosphates, and more preferably pyrethroid insecticides.

In an embodiment, the application is made simultaneously or separately or sequentially on a plant or a part thereof or at the locus or on the surface of plant propagation material.

The compositions used in the present invention comprises active pyridylidene compound that is flupyrimin or agriculturally acceptable salts, n-oxide, co-crystal, solvate, esters, enantiomers or diastereomers, mixtures of different crystalline states as well as amorphous or crystalline salts thereof.

The inventors of the present invention have conducted studies for finding out a method for reducing damage by harmful insect pests in corn cultivation, and surprisingly found out that damage by harmful insects in corn cultivation can be significantly reduced by contacting the plant or any plant parts including seeds and roots with flupyrimin or its agriculturally acceptable salts. Further, the present invention provides a method of controlling insects that are resistant to one or more neonicotinoid insecticide, preferably Group 4 insecticides of IRAC classification.

Specific examples of insect pests which can be controlled by the present invention include insect pests belonging to Agriotes spp., Diabrotica spp., Delia spp., Dalbulus spp., Agrotis spp., Myzus spp., Aphis spp., Ostrinia spp., Zyginidia spp., Sesamia spp., Oscinella spp., Sitobion spp., Scutigerella spp., Astylus spp., Rhopalosiphum spp., Metopolophium spp., Melanotus spp., Spodoptera spp. and Melolontha spp.

In another embodiment, the present invention provides a method to control the pests in corn, particularly, Peregrinus maidis (corn planthopper), Cicadulina mbila (corn Leafhopper), Heteronychus arator (black maize beetle), Empoasca decipiens (green leafhopper), Empoasca fabae (potato leafhopper).

In an embodiment the present invention is preferably applied as a method for reducing damage by insects of Diabrotica spp., Delia spp., or Dalbulus spp.

In an embodiment, the target insects that are controlled with the compound of the present invention are Diabrotica virgifera virgifera (corn rootworm), Dalbulus maidis (corn leafhopper), Delia platura (seed Corn Maggot) and Spodoptera frugiperda (fall army worm).

In further embodiment, the target pests that are controlled with compound of the present invention include, the pests belonging to the species of Phyllophaga cuyabana, Anomala corpulenta, Holotrichia diomphalia, Holotrichia oblita.

In an embodiment, the present invention provides a method of controlling insects which are resistant to one or more insecticides, particularly neonicotinoids of Group 4 of IRAC classification.

In an embodiment the pests that are controlled by the present invention are resistance to insecticides selected from the group consisting of Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, Xylylcarb, Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, Vamidothion, Chlordane, Endosulfan, Ethiprole, Fipronil, Acrinathrin, Allethrin, d-cis-trans Allethrin, d-trans Allethrin, Bifenthrin, Bioallethrin, Bioallethrin Scyclopentenyl isomer, Bioresmethrin, Cycloprothrin, Cyfluthrin, beta-Cyfluthrin, Cyhalothrin, lambda Cyhalothrin, gamma-Cyhalothrin, Cypermethrin, alpha-Cypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin, Methoxychlor, Acetamiprid, Clothianidin, Dinotefuran, Imidacloprid, Nitenpyram, Thiacloprid, Thiamethoxam, Nicotine, Sulfoxaflor, Flupyradifurone, Triflumezopyrim, Spinetoram, Spinosad, Abamectin, Emamectin benzoate, Lepimectin, Milbemectin, Hydroprene, Kinoprene, Methoprene, Fenoxycarb, Pyriproxyfen, Methyl bromide and other alkyl halides, Chloropicrin, Cryolite (Sodium aluminum fluoride), Sulfuryl fluoride, Borax, Boric acid, Disodium octaborate, Sodium borate, Sodium metaborate, Tartar emetic, Dazomet, Metam, Pymetrozine, Pyrifluquinazon, Afidopyropen, Clofentezine, Diflovidazin, Hexythiazox, Etoxazole, Diafenthiuron, Azocyclotin, Cyhexatin, Fenbutatin oxide, Propargite, Tetradifon, Chlorfenapyr, Sulfluramid, Bensultap, Cartap hydrochloride, Thiocyclam, Thiosultap-sodium, Bistrifluron, Chlorfluazuron, Diflubenzuron, Flucycloxuron, Flufenoxuron, Hexaflumuron, Lufenuron, Novaluron, Noviflumuron, Teflubenzuron, Triflumuron, Buprofezin, Cyromazine, Chromafenozide, Halofenozide, Methoxyfenozide, Tebufenozide, Amitraz, Hydramethylnon, Acequinocyl, Fluacrypyrim, Bifenazate, Fenazaquin, Fenpyroximate, Pyridaben, Pyrimidifen, Tebufenpyrad, Tolfenpyrad, Rotenone (Derris), Indoxacarb, Metaflumizone, Spirodiclofen, Spiromesifen, Spiropidion, Spirotetramat, Aluminium phosphide, Calcium phosphide, Phosphine, Zinc phosphide, Calcium cyanide, Potassium cyanide, Sodium cyanide, Cyenopyrafen, Cyflumetofen, Pyflubumide, Chlorantraniliprole, Cyantraniliprole, Cyclaniliprole Flubendiamide, Tetraniliprole, Broflanilide, and Fluxametamide.

In an embodiment, the present method is applied to control the insects that are resistant to imidacloprid.

In an embodiment, the present method is applied to control the insects that are resistant to clothianidin.

In an embodiment the, present method is applied to control the insects that are resistant to thiamethoxam.

The variety of corn, to which the present invention can be applied, is not particularly limited, but application of corn to a hybrid variety can also be preferable. The hybrid variety is first cross obtained by mating two different type of varieties, and generally has more excellent characteristics than those of both parents.

Corn may be genetically engineered to impart resistance. In an embodiment the corm is genetically modified (GMO) corm or GMO corn plant.

In an embodiment, the present invention provides a composition for treatment of plant or plant propagation material including seeds and roots, comprising flupyrimin or agriculturally acceptable salts optionally with at least one agrochemically acceptable excipient.

In an embodiment, the plant propagation material is a seed.

In an embodiment the plant propagation material is a GMO seed.

The term seed embraces seeds and plant propagules of all kinds including but not limited to true seeds, seed pieces, suckers, corms, bulbs, fruit, tubers, grains, cuttings, cut shoots, plantlets and the like.

The active compound, flupyrimin is particularly suitable for use in the treatment of corn seeds in order to protect the seeds from insect pests, in particular from soil-living insect pests, and the resulting seedling's roots and shoots against soil pests and foliar insects. The invention therefore also relates to a method for the protection of corn seeds from insects, in particular from soil insects, and of the seedling's roots and shoots from insects, in particular from soil and foliar insects, said method comprising treating the seeds before sowing and/or after pre-germination with a composition comprising flupyrimin or agriculturally acceptable salts.

In treatment of plant propagation materials such as seeds, e. g. by dusting, coating or drenching seed, amounts of active substance of from 0.1 to 1000 g per 100 kilogram of plant propagation material (preferably seeds) are generally required.

In an embodiment, the concentration of flupyrimin is in the range from 10 to 1000 grams per 100 kg of seeds i.e 1 to 10 gm per kg of seeds.

In another embodiment, the concentration of flupyrimin is in the range from 50 to 900 grams per 100 kg of seeds.

In another embodiment, the concentration of flupyrimin is in the range from 100 to 800 grams per 100 kg of seeds.

In another embodiment, the concentration of flupyrimin is in the range from 100 to 700 grams per 100 kg of seeds.

In another embodiment, the concentration of flupyrimin is in the range from 100 to 600 grams per 100 kg of seeds.

In another embodiment, the concentration of flupyrimin is in the range from 100 to 500 grams per 100 kg of seeds.

In another embodiment, the concentration of flupyrimin is in the range from 100 to 400 grams per 100 kg of seeds.

In another embodiment, the concentration of flupyrimin is in the range from 100 to 300 grams per 100 kg of seeds.

In another embodiment, the concentration of flupyrimin is in the range from 100 to 200 grams per 100 kg of seeds.

In a preferred embodiment, the present invention provides use of said compositions for controlling corn rootworm, corn leafhopper or seed corn maggot.

In an embodiment the present compositions are used for seed treatment of plants.

The term seed treatment comprises all suitable seed treatment techniques known in the art, such as seed dressing, seed coating, seed dusting, seed soaking and seed pelleting.

In an aspect the present invention provides a seed treatment composition comprising flupyrimin or its agriculturally acceptable salts.

In an embodiment the present invention provides a seed treatment composition for controlling corn rootworm, corn leafhopper or seed corn maggot.

In the treatment of seeds, the present formulations are commonly applied by treating the seeds with an effective amount of the compositions of the invention. The term “effective amount” denotes an amount of the composition or of the compounds of the invention, which is sufficient for controlling the pests on cultivated plants or in the protection of materials and which does not result in a substantial damage to the treated plants or crop.

In another aspect, the present invention provides a propagule coated with a composition of biologically effective amount of flupyrimin, an N-oxide thereof or an agriculturally suitable salt thereof.

In an embodiment, the present invention pertains to methods for protecting a propagule or a plant grown therefrom, from invertebrate pests comprising contacting the propagule or the locus of the propagule with a biologically effective amount of flupyrimin, an N-oxide thereof or an agriculturally suitable salt thereof.

According to the present invention the application can be carried out both before and after the infestation of the crops, plants, plant propagation materials, such as seeds, soil, seeds, roots, or the area, material, or environment by the pests.

Suitable application methods include inter alia soil treatment, seed treatment, in furrow application, and foliar application. Soil treatment methods include drenching the soil, drip irrigation (drip application onto the soil), dipping roots, tubers or bulbs, or soil injection. Seed treatment method include seed dressing, seed coating, seed dusting, seed soaking, and seed pelleting.

In an embodiment the application of the compounds of the invention can be performed by seed dressing or seed coating. In an embodiment the application of the compounds of the invention can be performed by foliar application.

When employed in plant protection, the formulation comprising active substances applied are, depending on the kind of effect desired, the formulation comprising active substances applied are, from 0.001 to 5 L per ha, preferably from 1 to 3 L per ha.

The method of the present disclosure can be carried out by application of the compositions comprising flupyrimin or agriculturally acceptable salts thereof to the soil or foliar applications. In an embodiment flupyrimin or agriculturally acceptable salts thereof at a rate of application from about 50 to about 700 g a.i./ha.

In an embodiment the application rate is preferably from about 100 to about 500 g a.i./ha.

In an embodiment the application rate is preferably from about 100 to about 400 g a.i./ha.

In an embodiment the application rate is preferably from about 100 to about 300 g a.i./ha.

In an embodiment, the composition for foliar application is selected from suspension concentrate (SC), flowable concentrates (FS), solutions (SL), suspoemulsions (SE), powders for dry treatment, water dispersible powders for slurry treatment, water-soluble powders and emulsion or gel formulation

In an embodiment, the seed treatment composition is selected from flowable concentrates (FS), solutions (SL), suspoemulsions (SE), powders for dry treatment, water dispersible powders for slurry treatment, water-soluble powders and emulsion or gel formulation. These formulations can be applied to the seed diluted or undiluted. Application to the seeds is carried out before sowing, either directly on the seeds or after having pregerminated the latter.

In an embodiment, the composition disclosed in the present invention is a ready-to-use formulations, which may be diluted by two-to-tenfold.

In a preferred embodiment, suspension concentrate comprising flupyrimin or agriculturally acceptable salts is used for foliar application. In an embodiment the formulation comprising flupyrimin or agriculturally acceptable salts is applied at an application rate from 1 to 3000 ml/ha.

In one preferred embodiment, suspension concentrate comprising flupyrimin or agriculturally acceptable salts is used for seed treatment. Typically, a formulation for seed treatment comprises about 1 to 800 g/L of flupyrimin active ingredient. In an embodiment the formulation comprises flupyrimin in the concentration range from about 10 to 500 g/L.

In a preferred embodiment, flowable concentrate (FS) comprising flupyrimin or agriculturally acceptable salts is used for seed treatment. Typically, a FS formulation may comprise 1 to 800 g/L of active ingredient. Typically, the active compound is applied at an application rate of 10 to 700 g per 100 kg of seeds, preferably at an application rate of 100 to 500 g per 100 kg of seeds.

Particularly preferred FS formulations of the compounds in the invention for seed treatment includes from 0.1 to 80% by weight of the active ingredient.

In another embodiment, the present invention provides a method of controlling insects, which are resistant to an insecticide, the method comprises applying or contacting to pests/insects flupyrimin or an acceptable salt, esters, stereoisomers, an isotopic form, N-oxide, polymorph a derivative or mixture thereof or composition comprising them optionally with additional insecticide towards which insects are resistant.

Typically the present method is provided to control the resistant insects using flupyrimin wherein the insects are resistant to Nicotinic acetylcholine receptor agonists (nAChR), which include neonicotinoids, e.g. acetamiprid, clothianidin, cycloxaprid, dinotefuran, imidacloprid, nitenpyram, thiacloprid and thiamethoxam; or the compounds 14,5-Dihydro-N-nitro-1-(2-oxiranylmethyl)-1H-imidazol-2-amine, (2E-)-1-[(6-Chloropyridin-3-yl)methyl]-N′-nitro-2-pentylidenehydrazinecarboximidamide; or 1-[(6-Chloropyridin-3-yl)methyl]-7-methyl-8-nitro-5-propoxy-1, 2, 3, 5,6,7-hexahydroimidazo[1,2-a]pyridine; or nicotine; sulfoxaflor; flupyradifurone or triflumezopyrim.

In an embodiment of the present invention there is provided a method of controlling insects which are resistant to a neonicotinoid insecticide such as imidacloprid, the method comprises applying a composition comprising flupyrimin or an acceptable salt, stereoisomers, an isotopic form, N-oxide, a derivative or mixture thereof to said resistant insects.

In an embodiment, the present invention provides a combination for controlling insects comprising flupyrimin and at least one additional insecticide.

Examples of the additional insecticide, include but are not limited to, acephate, dichlorvos, fenitrothion, fenamifos, flonicamid, prothiophos. (Prothiofos), profenofos, pyraclofos, chlorpyrifos-methyl, diazinon, phosthiazate, imisiophos 1, Thiodicarb, aldicarb, Oxamyl, propoxur, carbaryl, fenobucarb, ethiofencarb, furothicarb, pirimicarb, pirimicarb, pirimicarb Carbamate compounds such as cartap and thiocyclam; nereistoxin derivatives such as diocyclol; organochlorine compounds such as dicofor and tetradiphon; permethrin and tefluthrin (teflu). hrin), cypermethrin, deltamethrin, cyhalothrin, fenvalerate, fulvalinate, etofenprox, etofenprox, silaflurin. Pyrethroid compounds; benzoylurea compounds such as diflubenzuron, teflubenzuron, flufenoxuron, chlorfluazuron; young formophors such as metoprene Molting hormone-like compounds such as chromafenozide; imidacloprid, clothianidin, thiamethoxam, acetamiprid, nitenpyromide, nitenpyramid Neonicotinoid compounds; Sulfoximine compounds such as sulfoxafluor; Butenolide compounds such as flupiradifurone; Diamide compounds such as Flubendiamide, Chlorantaniliprol, Cyantraniprole tetraniliprole, etiprole; fipronil, pyraprole, GA (Γ-aminobutyric acid) receptor-acting compounds; Chlorine channel-acting isoxazole compounds such as brofuranilide; pyridaben, fenpyroxymate, pyrimidifene, tebufenpyrad, tebufenpyrad Respiratory chain electron transport complex I inhibitor compounds such as fenpyrad; Respiratory chain electron transport complex II inhibitor compounds such as cyflumetofen, cienopyrafen, piflbumide; fluripyrimpy Respiratory chain electron transport complex III inhibitors such as acequinocyl and flometoquin; Accelase compounds such as spirodiclofen, spiromesifen and spirotetramat Spinosad, avermectin (avermect) n), milbemycin (Milbemycin), spinetoram (spinetoram), lepimectin (lepimectin), include macrolide compounds such as emamectin benzoate (emamectin benzoate).

Also, buprofezin, hexythiazox, amitraz, chlordiform, etoxazole, pymetrozine, pymetrozine, pymetrozine, pymetrozine (Pyriproxyfen), indoxacarb, pyridalyl, pyrifluquinazone, metaflumizone, hydramethylnonr, triazamate azamate, afidopyropen, renofluthrin, chloroparalethrin, cyhalodiamide, fluazintoline, fluazindoline, fluazaindolin-Momfluorothrin, kappa-bifenthrin, kappa-tefluthrin, fluhexafon, tioxazafen, momfluorosulin (momfluorin) rin), heptafluthrin, pyriminostrobin, cycloxapride, organometallic compounds, dinitro compounds, organosulfur compounds, urea compounds, triazine compounds, hydrazine compounds. Furthermore, agrochemically acceptable salts of these compounds are also included.

In an embodiment, the additional insecticide is selected from the class of diamides, benzoylureas and flonicamid.

In an embodiment, the diamide class of insecticides are selected from chlorantraniliprole, cyantraniliprole, cyclaniliprole flubendiamide, and tetraniliprole.

In another embodiment, the diamide class of insecticide is chlorantraniliprole.

In an embodiment, the benzoylurea class of insecticide are selected from Bistrifluron, Chlorfluazuron, Diflubenzuron, Flucycloxuron, Flufenoxuron, Hexaflumuron, Lufenuron, Novaluron, Noviflumuron, and Teflubenzuron, Triflumuron.

In another embodiment, the diamide class of insecticide is diflubezuron.

In another embodiment, the additional insecticide is flonicamid.

In an embodiment, the present invention provides a composition comprising flupyrmin or agriculturally acceptable salts or esters thereof, optionally at least one additional insecticide and/or agrochemically acceptable excipient.

In an embodiment, the present invention provides an insecticidal composition comprising a pyridylidene insecticide, wherein the pyridylidene insecticide is in a concentration ranging from 1% to 100% w/w, preferably the pyridylidene insecticide is in a concentration ranging from 1% to 80% w/w, more preferably the pyridylidene insecticide is in a concentration ranging from 1% to 50% w/w.

In an embodiment the a pyridylidene insecticide comprises flupyrimin or agriculturally acceptable salts or esters thereof.

In an embodiment, the present invention provides a composition for controlling insects comprising flupyrimin and at least one agrochemically acceptable excipient.

In an embodiment, the present invention provides a composition for controlling corn insects comprising flupyrimin or agriculturally acceptable salts or esters thereof, at least one additional insecticide and at least one agrochemically acceptable excipients.

In an embodiment, the agrochemically acceptable excipients are selected from disintegrant, binder, glidant, emulsifiers, anticaking agents, pH-regulating agents, preservatives, biocides, antifoaming agents, colorants, stabilizers, and other formulation aids.

Emulsifiers which can be advantageously employed herein can be readily determined by those skilled in the art and include various non-ionic, anionic, cationic, and amphoteric emulsifiers, or a blend of two or more emulsifiers. Examples of non-ionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs, or metal phthalocyanine dyestuffs, and trace elements, such as salts of iron, manganese, boron, copper, cobalt, molybdenum, and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, and octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoam agent may be selected from Polydimethoxysiloxane, polydimethylsiloxane, alkyl poly acrylates, castor oil, fatty acids, fatty acids esters, fatty acids sulfate, fatty alcohol, fatty alcohol esters, fatty alcohol sulfate, foot olive oil, mono & di glyceride, paraffin oil, paraffin wax, poly propylene glycol, silicones oil, vegetable fats, vegetable fats sulfate, vegetable oil, vegetable oil sulfate, vegetable wax, vegetable wax sulfate, agents based on silicon or magnesium stearate.

The agrochemical formulation may also comprise one or more antioxidants. Preferably, the agrochemical formulation comprises an antioxidant. Antioxidants are, for example, amino acids (e.g. glycine, histidine, tyrosine, tryptophan) and derivatives thereof, imidazole and imidazole derivatives (e.g. urocanic acid), peptides, such as, for example, D,L-carnosine, D-carnosine, L-carnosine and derivatives thereof (e.g. anserine), carotenoids, carotenes (e.g. α-carotene, β-carotene, lycopene) and derivatives thereof, lipoic acid and derivatives thereof (e.g. dihydrolipoic acid), aurothioglucose, propylthiouracil and further thio compounds (e.g. thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol/kg to pmol/kg), also metal chelating agents (e.g. α-hydroxy fatty acids, EDTA, EGTA, phytic acid, lactoferrin), α-hydroxy acids (e.g. citric acid, lactic acid, malic acid), humic acids, bile acid, bile extracts, gallic esters (e.g. propyl, octyl and dodecyl gallate), flavonoids, catechins, bilirubin, biliverdin and derivatives thereof, unsaturated fatty acids and derivatives thereof (e.g. γ-linolenic acid, linoleic acid, arachidonic acid, oleic acid), folic acid and derivatives thereof, hydroquinone and derivatives thereof (e.g. arbutin), ubiquinone and ubiquinol, and derivatives thereof, vitamin C and derivatives thereof (e.g. ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g. tocopheryl acetate, linoleate, oleate and succinate, tocophereth-5, tocophereth-10, tocophereth-12, tocophereth-18, tocophereth-50, tocophersolan), vitamin A and derivatives (e.g. vitamin A palmitate), the coniferyl benzoate of benzoin resin, rutin, rutinic acid and derivatives thereof, disodium rutinyl disulfate, cinnamic acid and derivatives thereof (e.g. ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g. selenomethionine), stilbenes and stilbene derivatives (e.g. stilbene oxide, trans-stilbene oxide). According to the invention, suitable derivatives (salts, esters, sugars, nucleotides, nucleosides, peptides, and lipids) and mixtures of these specified active ingredients or plant extracts (e.g., teatree oil, rosemary extract and rosemarinic acid) which comprise these antioxidants can be used. In general, mixtures of the aforementioned antioxidants are possible.

According to an embodiment, examples of suitable solvents are water, aromatic solvents (for example, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

In an aspect, the present invention provides a method of improving yield of a plant, said method comprising application of compositions of present invention at the locus of the plant, such that the said composition controls the target harmful insects.

In an embodiment, the constituents of the composition used in the present invention may be applied as per known methods of application to seeds, roots, soil or plants and other plant propagation material or transplanted saplings.

In an embodiment of the present invention, the compositions can be formulated into either solid or liquid formulations that are suitable for application to a plant or a part thereof or a propagation material. The formulation may be made as known formulation types such as, solutions (LS), emulsions (ES), suspension concentrates, flowable suspension (FS), water dispersible granule (WG), or aqueous suspension concentrate (CS).

The compositions of the present invention may also be formulated as aerosol dispenser, capsule suspension, cold fogging concentrate, dustable powder, emulsifiable concentrate, emulsion oil in water, emulsion water in oil, encapsulated granule, fine granule, flowable suspension or flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra-low volume (ULV) liquid, ultra-low volume (ULV) suspension, water dispersible granules or tablets, water dispersible powder for slurry treatment, water soluble granules or tablets, water soluble powder for seed treatment and wettable powder.

The formulation may be applied by various methods such methods using conventional treating techniques and machines, such as fluidized bed techniques, the roller mill method, drones, rotostatic seed treaters, and drum coaters, spouted beds etc. pre and post coating procedures such as sizing etc., may also be carried out. Such procedures are known in the art.

Another embodiment of the present invention provides a method of controlling corn pests comprising applying flupyrimin or agriculturally acceptable salts or esters thereof, to plant, plant part, propagule, plant propagation material or a locus thereof.

Another embodiment of the present invention provides a method of controlling corn pests comprising applying to plant, plant part, root, seeds or a locus thereof a composition comprising flupyrimin or agriculturally acceptable salts or esters thereof.

Below are the non-limiting examples of pests against which the compositions of the present invention are effective:
pests from the phylum Arthropoda, especially from the class Arachnida, for example, Acarus spp., Aceria sheldoni, Aculops spp., Aculus spp., Amblyomma spp., Amphitetranychus viennensis, Argas spp., Boophilus spp., Brevipalpus spp., Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., Epitrimerus pyri, Eutetranychus spp., Eriophyes spp., Glycyphagus domesticus, Halotydeus destructor, Hemitarsonemus spp., Hyalomma spp., Ixodes spp., Latrodectus spp., Loxosceles spp., Metatetranychus spp., Neutrombicula autumnalis, Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., Tetranychus spp., Trombicula alfreddugesi, Vaejovis spp., Vasates lycopersici;
from the class Chilopoda, for example, Geophilus spp., Scutigera spp.;
from the order or the class Collembola, for example, Onychiurus armatus;
from the class Diplopoda, for example, Blaniulus guttulatus;
from the class Insecta, e.g. from the order Blattodea, for example, Blattella asahinai,
Blattella germanica, Blatta orientalis, Leucophaea maderae, Panchlora spp., Parcoblatta spp., Periplaneta spp., Supella longipalpa;
from the order Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptolestes ferrugineus, Cryptorhynchus lapathi, Cylindrocopturus spp., Dermestes spp., Diabrotica spp., Dichocrocis spp., Dicladispa armigera, Diloboderus spp., Epilachna spp., Epitrix spp., Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., Lachnosterna consanguinea, Lasioderma serricorne, Latheticus oryzae, Lathridius spp., Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Necrobia spp., Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllophaga helleri, Phyllotreta spp., Popillia japonica, Premnotrypes spp., Prostephanus truncatus, Psylliodes spp., Ptinus spp., Rhizobius ventralis, Rhizopertha dominica, Sitophilus spp., Sitophilus oryzae, Sphenophorus spp., Stegobium paniceum, Sternechus spp., Symphyletes spp., Tanymecus spp., Tenebrio molitor, Tenebrioides mauretanicus, Tribolium spp., Trogoderma spp., Tychius spp., Xylotrechus spp., Zabrus spp.;
from the order Diptera, for example, Aedes spp., Agromyza spp., Anastrepha spp., Anopheles spp., Asphondylia spp., Bactrocera spp., Bibio hortulanus, Calliphora erythrocephala, Calliphora vicina, Ceratitis capitata, Chironomus spp., Chrysomyia spp., Chrysops spp., Chrysozona pluvialis, Cochliomyia spp., Contarinia spp., Cordylobia anthropophaga, Cricotopus sylvestris, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hydrellia griseola, Hylemya spp., Hippobosca spp., Hypoderma spp., Liriomyza spp., Lucilia spp., Lutzomyia spp., Mansonia spp., Musca spp., Oestrus spp., Oscinella frit, Paratanytarsus spp., Paralauterborniella subcincta, Pegomyia spp., Phlebotomus spp., Phorbia spp., Phormia spp., Piophila casei, Prodiplosis spp., Psila rosae, Rhagoletis spp., Sarcophaga spp., Simulium spp., Stomoxys spp., Tabanus spp., Tetanops spp., Tipula spp.;
from the order Heteroptera, for example, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptocorisa varicornis, Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.;
from the order Homoptera, for example, Acizzia acaciaebaileyanae, Acizzia dodonaeae, Acizzia uncatoides, Acrida turrita, Acyrthosipon spp., Acrogonia spp., Aeneolamia spp., Agonoscena spp., Aleyrodes proletella, Aleurolobus barodensis, Aleurothrixus floccosus, Allocaridara malayensis, Amrasca spp., Anuraphis cardui, Aonidiella spp., Aphanostigma piri, Aphis spp., Arboridia apicalis, Arytainilla spp., Aspidiella spp., Aspidiotus spp., Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., Calligypona marginata, Carneocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus ficus, Cicadulina mbila, Coccomytilus halli, Coccus spp., Cryptomyzus ribis, Cryptoneossa spp., Ctenarytaina spp., Dalbulus spp., Dialeurodes citri, Diaphorina citri, Diaspis spp., Drosicha spp., Dysaphis spp., Dysmicoccus spp., Empoasca spp., Eriosoma spp., Erythroneura spp., Eucalyptolyma spp., Euphyllura spp., Euscelis bilobatus, Ferrisia spp., Geococcus coffeae, Glycaspis spp., Heteropsylla cubana, Heteropsylla spinulosa, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Macrosteles facifrons, Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nettigoniclla spectra, Nilaparvata lugens, Oncometopia spp., Orthezia praelonga, Oxya chinensis, Pachypsylla spp., Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Prosopidopsylla flava, Protopulvinaria pyriformis, Pseudaulacaspis pentagona, Pseudococcus spp., Psyllopsis spp., Psylla spp., Pteromalus spp., Pyrilla spp., Quadraspidiotus spp., Quesada gigas, Rastrococcus spp., Rhopalosiphum spp., Saissetia spp., Scaphoideus titanus, Schizaphis graminum, Selenaspidus articulatus, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., Trialeurodes vaporariorum, Trioza spp., Typhlocyba spp., Unaspis spp., Viteus vitifolii, Zygina spp.;
from the order Hymenoptera, for example, Acromyrmex spp., Athalia spp., Atta spp., Diprion spp., Hoplocampa spp., Lasius spp., Monomorium pharaonis, Sirex spp., Solenopsis invicta, Tapinoma spp., Urocerus spp., Vespa spp., Xeris spp.;
from the order Isopoda, for example, Armadillidium vulgare, Oniscus asellus, Porcellio scaber;
from the order Isoptera, for example, Coptotermes spp., Cornitermes cumulans, Cryptotermes spp., Incisitermes spp., Microtermes obesi, Odontotermes spp., Reticulitermes spp.;
from the order Lepidoptera, for example, Achroia grisella, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., Choristoneura spp., Clysia ambiguella, Cnaphalocerus spp., Cnaphalocrocis medinalis, Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamstra brassicae, Melanitis leda, Mocis spp., Monopis obviella, Mythimna separata, Nemapogon cloacellus, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudaletia unipuncta, Pseudoplusia includens, Pyrausta nubilalis, Rachiplusia nu, Schoenobius spp., Scirpophaga spp., Scirpophaga innotata, Scotia segetum, Sesamia spp., Sesamia inferens, Sparganothis spp., Spodoptera spp. (Fall Armyworm), Spodoptera praefica, Spodoptera frugiperda, Stathmopoda spp., Stomopteryx subsecivella, Synanthedon spp., Tecia solanivora, Thermesia gemmatalis, Tinea cloacella, Tinea pellionella, Tineola bisselliella, Tortrix spp., Trichophaga tapetzella, Trichoplusia spp., Tryporyza incertulas, Tuta absoluta, Virachola spp.;
from the order Orthoptera or Saltatoria, for example, Acheta domesticus, Dichroplus spp., Gryllotalpa spp., Hieroglyphus spp., Locusta spp., Melanoplus spp., Schistocerca gregaria;
from the order Phthiraptera, for example, Damalinia spp., Haematopinus spp., Linognathus spp., Pediculus spp., Ptirus pubis, Trichodectes spp.;
from the order Psocoptera for example Lepinatus spp., Liposcelis spp.;
from the order Siphonaptera, for example, Ceratophyllus spp., Ctenocephalides spp., Pulex irritans, Tunga penetrans, Xenopsylla cheopsis;
from the order Thysanoptera, for example, Anaphothrips obscurus, Baliothrips biformis, Drepanothrips reuteri, Enneothrips flavens, Frankliniella spp., Heliothrips spp., Hercinothrips femoralis, Rhipiphorothrips cruentatus, Scirtothrips spp., Taeniothrips cardamomi, Thrips spp.;
from the order Zygentoma (Thysanura), for example, Ctenolepisma spp., Lepisma saccharina, Lepismodes inquilinus, Thermobia domestica;
from the class Symphyla, for example, Scutigerella spp.;
pests from the phylum Mollusca, especially from the class Bivalvia, for example, Dreissena spp., and from the class Gastropoda, for example, Anion spp., Biomphalaria spp., Bulinus spp., Deroceras spp., Galba spp., Lymnaea spp., Oncomelania spp., Pomacea spp., Succinea spp.;
animal pests from the phylums Plathelminthes and Nematoda, for example, Ancylostoma duodenale, Ancylostoma ceylanicum, Acylostoma braziliensis, Ancylostoma spp., Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti;
phytoparasitic pests from the phylum Nematoda, for example, Aphelenchoides spp., Bursaphelenchus spp., Ditylenchus spp., Globodera spp., Heterodera spp., Longidorus spp., Meloidogyne spp., Pratylenchus spp., Radopholus spp., Trichodorus spp., Tylenchulus spp., Xiphinema spp., Helicotylenchus spp., Tylenchorhynchus spp., Scutellonema spp., Paratrichodorus spp., Meloinema spp., Paraphelenchus spp., Aglenchus spp., Belonolaimus spp., Nacobbus spp., Rotylenchulus spp., Rotylenchus spp., Neotylenchus spp., Paraphelenchus spp., Dolichodorus spp., Hoplolaimus spp., Punctodera spp., Criconemella spp., Quinisulcius spp., Hemicycliophora spp., Anguina spp., Subanguina spp., Hemicriconemoides spp., Psilenchus spp., Pseudohalenchus spp., Criconemoides spp., Cacopaurus spp., Hirschmaniella spp, Tetylenchus spp.
Other pests such as wireworms, for example, Agroites spp., Limonius spp., Elateridae spp., Acolus spp., Conoderus spp., Melanotus spp., Dalopius spp. Tenebrionidae spp., Hypnoidus spp., Eleodes spp can be controlled or prevented using the present composition comprising flupyrimin optionally with additional insecticides.

The method of the present invention can offer some particular advantages over the conventional methods. The method of the present invention effectively protects the crop from insects and improves yield and promotes plant health and has no phytotoxicity. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, easier harvesting, high harvest yields, high quality and/or a higher nutritional value of the harvested products, to be expected.

According to an embodiment of the present disclosure, a kit-of-parts comprising an agrochemical composition is provided. The kit comprises a plurality of components, each of which components may include at least one of the ingredients of the agrochemical composition of the present disclosure.

An embodiment of the present invention discloses a kit-of-parts comprising an agrochemical composition for controlling infestation of corn insects, comprising flupyrimin and optionally at least one additional active ingredient and/or agrochemically acceptable excipient.

In one embodiment of the present disclosure, the kits may include one or more, including all, components that may be used to prepare the agrochemical composition e. g., kits may include pyridylidene insecticide, another insecticide and agrochemically acceptable excipient. One or more of the components may already be combined or pre-formulated. In those embodiments where more than two components are provided in a kit, the components may already be combined and as such are packaged in a single container such as a vial, bottle, can, pouch, bag, or canister.

The invention shall now be described with reference to the following specific examples. It should be noted that the examples appended below illustrate rather than limit the invention and that those skilled in the art will be able to design many alternative embodiments without departing from the scope of the present invention.

### EXAMPLES

### Formulation Example

| Sr. No. | Ingredients | Amount % |
|---|---|---|
| 1 | Flupyrimin | 41.67 |
| 2 | Naphthalene sulfonate | 3 |
| | condensate, sodium salt | |
| 3 | Acrylic copolymer solution | 3 |
| 4 | Propylene glycol | 5 |
| 5 | Water | Q.S. |
| | Total | 100 |

### Example 1: Efficacy of Flupyrimin Against Corn Rootworm (Diabrotica virgifera Virgifera)

Trials were carried out in field to assess efficacy of flupyrimin against corn rootworm (Diabrotica virgifera virgifera). Seeds were treated with flupyrimin before sowing. Evaluation was done to check % control of said insects at different dosage. Soil Texture=clay loam, pH=6.89, OM %=3.29.

TABLE 1

| | | Concentration | |
|---|---|---|---|
| Sr No. | Treatment name | (g/100 kg of seeds) | % Control |
| 1 | Untreated check | 0 | 0 |
| 2 | Flupyrimin | 100 | 49.39 |
| 3 | Flupyrimin | 200 | 70.4 |
| 4 | Flupyrimin | 300 | 96.38 |
| 5 | Flupyrimin | 400 | 99.36 |
| 6 | Flupyrimin | 500 | 100 |

The above data establishes that flupyrimin shows good insect control against corn rootworm (Diabrotica virgifera virgifera).

Further, the damage index (Scale 1-6) at different concentrations was evaluated.

### Damage Index:

Assessment of the amount of damage by larval feeding of D. virgifera on corn roots were made by digging out the root system taking a diameter of approximately 25 cm to a depth of 15 cm. The root systems were then washed so that all crown roots were fairly clean. Damage on the root systems was assessed on 10 plants per plot (40 plants per treatment) using a scale as the following:
1.0=no feeding damage;
1.5=visible feeding scars present (not illustrated, but similar to a rating of two);
2.0=up to three roots pruned slightly;
2.5=more than three roots pruned, but none chewed to within 4 cm of plant;
3.0=one to three roots chewed to within 4 cm of plant;
3.5=more than three roots chewed to within 4 cm of plant;
4.0=one entire node or equivalent number of roots destroyed
4.5=about 1.5 nodes destroyed
5.0=two nodes destroyed
5.5=about 2.5 nodes destroyed
6.0=three or more nodes completely destroyed (not illustrated, but similar to a rating of five)

The results are represented as follows:

TABLE 2
Corn rootworm

| | | Concentration | Damage |
|---|---|---|---|
| Sr No. | Treatment name | (g/100 kg of seeds) | Index |
| 1 | Untreated check | 0 | 3.5 |
| 2 | Flupyrimin | 100 | 2.3 |
| 3 | Flupyrimin | 200 | 1.8 |
| 4 | Flupyrimin | 300 | 1.1 |
| 5 | Flupyrimin | 400 | 1 |
| 6 | Flupyrimin | 500 | 1 |

The above data establishes that flupyrimin at different concentration is efficacious in reducing the damage caused by cotton rootworm.

### Example 2: Efficacy of Flupyrimin on Seed Corn Maggot (Delia platura)

Trials were carried out in field to assess efficacy of flupyrimin against seed corn maggot (Delia platura). Seeds were treated with flupyrimin before sowing. Evaluation was done to evaluate pest severity of said insects at different dosage. Soil Texture=fine sandy loam, pH=7, OM %=0.8.

TABLE 3
Seed corn maggot

| | | | Pest severity | | | |
|---|---|---|---|---|---|---|
| Sr | Treatment | Concentration | 14 | 28 | 35 | 42 |
| No. | name | (g/100 kg of seeds) | DP | DP | DP | DP |
| 1 | Untreated check | 0 | 0.6 | 3.2 | 4.1 | 4.8 |
| 2 | Flupyrimin | 100 | 0.2 | 4.3 | 4.8 | 5.9 |
| 3 | Flupyrimin | 200 | 0 | 0.7 | 0.9 | 1.8 |
| 4 | Flupyrimin | 300 | 0 | 0.3 | 0.5 | 0.9 |
| 5 | Flupyrimin | 400 | 0 | 0.3 | 0.5 | 1.1 |
| 6 | Flupyrimin | 500 | 0 | 0 | 0 | 0.3 |

The above table represents flupyrimin is effective against seed corn maggot (Delia platura).

### Example 3: Efficacy of Flupyrimin on Corn Leafhopper (Dalbulus maidis)

Trials were carried out in field to assess efficacy of flupyrimin against Corn leafhopper (Dalbulus maidis). Evaluation was done to check % control of adult insects per plant at different dosage at 3 days after emergence and 7 days after emergence.

TABLE 4

| | | | | % Control | |
|---|---|---|---|---|---|
| | Treatment | Concentration | Rate | 3 | 7 |
| Sr No. | name | (g ai/100 kg) | (Kg-L/ha) | DAE | DAE |
| 1 | Flupyrimin | 100 | 0.2 | 65 | 50 |
| 2 | Flupyrimin | 200 | 0.4 | 50.91 | 45.83 |
| 3 | Flupyrimin | 300 | 0.6 | 86.93 | 47.02 |
| 4 | Flupyrimin | 500 | 1.0 | 80 | 63.69 |

The above table it is evident that flupyrimin shows good control of corn leafhopper (Dalbulus maidis).

### Example 4: Efficacy of Flupyrimin on Fall Army Worm (Spodoptera frugiperda)

Trials were carried out in the field to assess efficacy of flupyrimin against fall army worm (Spodoptera frugiperda) in corn plantation. Evaluation was done to check % control of said insects at different dosage for 3, 7, 10, 14 DAA for 1^{st} application and 3, 7, 10, 14, 21, 28, 35, and 42 DAA for 2^{nd} application. The rate of application was 500 lit/ha.

TABLE 5
Efficacy -Corn- Fall Army Worm: Percent
control: Post 1^{st} application

| | | | | % Control | | | |
|---|---|---|---|---|---|---|---|
| Sr | | Active | Formulated | 3 | 7 | 10 | 14 |
| No. | Treatment | g a.i./ha | (g/ha) | DAA | DAA | DAA | DAA |
| 1 | Untreated | — | — | [1.9] | [2.0] | [2.4] | [3.0] |
| | Control | | | | | | |
| 2 | Flupyrimin | 150 | 1500 | 27.8 | 29.1 | 28.1 | 24.4 |
| 3 | Flupyrimin | 200 | 2000 | 32.8 | 34.1 | 33.7 | 29.5 |
| 4 | Flupyrimin | 250 | 2500 | 38.1 | 40.1 | 36.7 | 32.9 |

TABLE 6
Efficacy -Corn- Fall Army Worm: Percent control: Post 2^{nd} application

| | | Active | Formulated | % Control | | | | | | | |
|---|---|---|---|---|---|---|---|---|---|---|---|
| | | dose rate | dose rate | 3 | 7 | 10 | 14 | 21 | 28 | 35 | 42 |
| No. | Treatment | g a.i./ha | (g/ha) | DAA | DAA | DAA | DAA | DAA | DAA | DAA | DAA |
| 1 | Untreated Control | — | — | [3.6] | [4.1] | [4.5] | [4.8] | [4.9] | [4.7] | [4.5] | [4.2] |
| 2 | Flupyrimin | 150 | 1500 | 28.3 | 30.4 | 31.8 | 32.6 | 29.9 | 28.9 | 27.3 | 27.1 |
| 3 | Flupyrimin | 200 | 2000 | 35.6 | 35.3 | 36.3 | 35.3 | 34.5 | 34.5 | 33.7 | 33.3 |
| 4 | Flupyrimin | 250 | 2500 | 41.4 | 42.7 | 43.7 | 44.4 | 41.4 | 38.8 | 38.1 | 37.9 |

### Example 5: Efficacy of Flupyrimin+Dibenzuron and Flupyrimin+Chlorantraniliprole on Spodoptera frugiperda (Fall Army Worm)

Trials were carried out in field to assess efficacy of flupyrimin+dibenzuron and flupyrimin+chlorantraniliprole against Spodoptera frugiperda (Fall army worm) in corn plantation. Evaluation was done to check % control of said insect at different dosage for 3, 7, 10, 14 DAA for 1^{st} application and 3, 7, 10, 14, 21, 28, 35, and 42 DAA. The rate of application was 500 lit/ha.

TABLE 7
Efficacy -Corn- Fall Army Worm: Percent control: Post 1^{st} application

| | | Dose rate | Dose rate | % Control | | | |
|---|---|---|---|---|---|---|---|
| Sr | | Active | Formulated | 3 | 7 | 10 | 14 |
| No. | Treatment | g a.i./ha | (g/ha) | DAA | DAA | DAA | DAA |
| 1 | Flupyrimin + | 100 + 75 | 1000 + 300 | 63.7 | 69.9 | 66.2 | 60.6 |
| | Diflubenzuron | | | | | | |
| 2 | Flupyrimin + | 150 + 80 | 1500 + 320 | 67 | 74.6 | 70.4 | 65 |
| | Diflubenzuron | | | | | | |
| 3 | Flupyrimin + | 100 + 30 | 1000 + 150 | 75.7 | 80.4 | 78.9 | 70.8 |
| | Chlorantraniliprole | | | | | | |
| 4 | Flupyrimin + | 150 + 40 | 1500 + 200 | 77 | 86.4 | 85.8 | 75.6 |
| | Chlorantraniliprole | | | | | | |

TABLE 8
Efficacy -Corn- Fall Army Worm: Percent control: Post 2^{nd} application

| | | Active g | Formulated | % Control | | | | | | | |
|---|---|---|---|---|---|---|---|---|---|---|---|
| | | dose rate | dose rate | 3 | 7 | 10 | 14 | 21 | 28 | 35 | 42 |
| no. | Treatment | a.i./ha | (g/ha) | DAA | DAA | DAA | DAA | DAA | DAA | DAA | DAA |
| 1 | Untreated Control | — | — | [3.6] | [4.1] | [4.51 | [4.8] | [4.9] | [4.7] | [4.5] | [4.2] |
| 2 | Flupyrimin + | 100 + 75 | 1000 + 300 | 67.8 | 73.8 | 73.4 | 74.3 | 68.7 | 68.3 | 67.6 | 66.8 |
| | Diflubenzuron | | | | | | | | | | |
| 3 | Flupyrimin + | 150 + 80 | 1500 + 320 | 74 | 78.6 | 77.7 | 78.5 | 74.1 | 74 | 72.7 | 72.2 |
| | Diflubenzuron | | | | | | | | | | |
| 4 | Flupyrimin + | 100 + 30 | 1000 + 150 | 80.9 | 85.2 | 87.5 | 85.4 | 80.3 | 80.3 | 80.2 | 79.3 |
| | Chlorantraniliprole | | | | | | | | | | |
| 5 | Flupyrimin + | 150 + 40 | 1500 + 200 | 86.2 | 90.2 | 92.6 | 89.6 | 86.5 | 85.9 | 84.5 | 84 |
| | Chorantraniliprole | | | | | | | | | | |

The above data establishes that combination of flupyrimin with diflubenzuron and combination of flupyrimin with chlorantraniliprole shows good control on fall armyworm.

We claim:

1. A method of controlling infestation of corn insects comprising:
applying flupyrimin or an agriculturally acceptable salts thereof on a plant or a part thereof or at the locus or on plant propagation material.

2. The method as claimed in claim 1, wherein the insects are selected from Diabrotica virgifera virgifer, Dalbulus maidis, Delia platura and Spodoptera frugiperd.

3. The method as claimed in claim 1, wherein the insect in corn comprises insect non-resistant or resistant to neonicotinoids.

4. The method as claimed in claim 3, wherein the neonicotinoids are selected from imidacloprid, clothianidin, or thiamethoxam.

5. The method as claimed in claim 1, wherein the plant propagation material is a seed.

6. The method as claimed in claim 1, wherein flupyrimin is applied as a composition selected from the group comprising a suspension concentrate, a flow concentrate, flowable suspension, a granular formulation, an emulsifiable concentrate, suspoemulsions or solutions.

7. The method as claimed in claim 1, wherein flupyrimin is applied in the range from 10 to 500 gm/100 kg of seeds.

8. The method as claimed in claim 1, wherein flupyrimin is applied at an application rate in the range from 10 to 700 g/ha.

9. The method as claimed in claim 1, wherein flupyrimin is applied with an additional insecticide.

10. The composition as claimed in claim 9, wherein the additional insecticide is selected from diamide, benzoylureas or flonicamid.

11. A composition for controlling infestation of corn insects, said composition comprising flupyrimin or agriculturallu acceptable salts or esters thereof, optionally at least one additional insecticide and at least one agrochemically acceptable excipient.

12. A kit-of-parts comprising an agrochemical composition for controlling infestation of corn insects, comprising flupyrimin and optionally at least one additional active ingredient and/or agrochemically acceptable excipient.
